(19) United States
(12) Patent Application Publication
(10) Pub. No.: US 2017/0219134 A1
(43) Pub. Date: Aug. 3, 2017

(54) Double-walled pipe element and method for producing a double-walled pipe element

(71) Applicant: Airbus Defence and Space GmbH, Ottobrunn (DE)

(72) Inventors: Florian KEDOR, Lilienthal (DE); Tobias FISLAGE, Bremen (DE); Ralf WOERDEMANN, Bremen (DE); Christian GRUETZMANN, Reinfeld (DE)

(21) Appl. No.: 15/422,167

(22) Filed: Feb. 1, 2017

(30) Foreign Application Priority Data
Feb. 2, 2016 (DE) 102016201547.8
Jan. 31, 2017 (DE) 102017201532.2

(51) Int. Cl. F16L 9/19; B64D 37/00; B33Y 80/00; B22F 5/10; B33Y 10/00; F16L 43/00; B22F 3/105

(52) U.S. Cl. CPC F16L 9/19; F16L 43/001; B64D 37/005; B22F 3/1055; B22F 5/106; B33Y 10/00; B33Y 80/00

(57) ABSTRACT

A pipe element suitable for use in a fuel system of an aircraft comprises an inner pipe and an outer pipe sealingly surrounding the inner pipe and connected to the inner pipe. The pipe element is constructed in one piece and is produced by a 3D printing process.

### CROSS-REFERENCES TO RELATED APPLICATIONS

This application claims the benefit of the German patent application No. 10 2016 201 547.8 filed on Feb. 2, 2016, and of the German patent application No. 10 2017 201 532.2 filed on Jan. 31, 2017, the entire disclosures of which are incorporated herein by way of reference.

### BACKGROUND OF THE INVENTION

The present invention relates to a pipe element suitable, in particular, for use in a fuel system of an aircraft. Furthermore, the invention relates to a method for producing such a pipe element.

Fuel-carrying pipes running through a pressurized fuselage region of an aircraft are usually of double-walled design, so that in the event of leakage, fuel escaping from an inner pipe is caught in an outer pipe. The outer pipe is connected to the aircraft surroundings via a suitable drainage system, whereby it is ensured that, in the event of leakage, fuel caught in the outer pipe can be safely discharged into the aircraft surroundings.

Double-walled fuel pipes currently installed in aircraft are produced in a multi-stage production process. In a first operation, firstly the inner pipe and the outer pipe are cast or machined separately from one another. Subsequently, a pre-machining of joining surfaces of the pipes is carried out. In the next step, the inner pipe and the outer pipe are welded to one another. Finally, in most cases, the final machining, i.e., finishing and fine machining of the component, is carried out.

### SUMMARY OF THE INVENTION

An object on which the present invention is based is to specify a pipe element suitable, in particular, for use in a fuel system of an aircraft which is producible simply and cost-effectively and, if required, with a complex geometry. Furthermore, an object on which the invention is based is to specify a method with which a pipe element suitable, in particular, for use in a fuel system of an aircraft, can be produced simply and cost-effectively and, if required, with a complex geometry.

A pipe element suitable, in particular, for use in a fuel system of an aircraft comprises an inner pipe and also an outer pipe sealingly surrounding the inner pipe and connected to the inner pipe. Such a design of the pipe element ensures that, in the event of leakage, liquid, for example fuel, escaping from the inner pipe is caught in the outer pipe. The liquid can then be discharged from the outer pipe, for example via a suitable drainage system.

The pipe element is constructed in one piece and produced by a 3D printing process. A 3D printing process is a generative layer-building process, by which powdered raw materials can be processed to form 3-dimensional workpieces of complex shape. For this purpose, a raw material powder layer is applied to a carrier and, depending on the desired geometry of the workpiece to be created, subjected to laser radiation at selected locations. The laser is controlled by means of CAD data. The laser radiation penetrating the powder layer causes heating and consequently fusion or sintering of the raw material powder particles. Subsequently, successively further raw material powder layers are applied to the already-radiated layer on the carrier until the workpiece has the desired shape and size.

By means of the 3D printing process, the inner pipe and the outer pipe can be produced simultaneously and in one piece. As a result, shorter production times and reduced production costs are made possible. Furthermore, very complex geometries, such as, for example, undercuts or the like, which are not realizable with conventional manufacturing processes, can be produced by 3D printing. As a result, the design of the pipe element can be optimized as regards its function and weight. Finally, the casting mold, required in a casting process, as an intermediate step for producing the cast blank, is no longer required.

In a preferred embodiment, the pipe element is composed of metal and is produced by a 3D metal printing process. The pipe element is then well-suited for use in a fuel system of an aircraft.

Preferably, the pipe element is composed of titanium or a titanium alloy. Titanium is a corrosion- and fire-resistant, lightweight material which is particular well-suited for producing pipe elements of an aircraft fuel system. Alternatively thereto, the pipe element can, however, also be made of other metallic materials, such as, for example, aluminum or steel alloys.

In a preferred embodiment of the pipe element, a surface of a component overhang which faces a horizontal base plane of the pipe element forms, with the horizontal base plane of the pipe element, an angle which is greater than 35°. The pipe element can then be printed without additional supporting elements for this surface. Preferably, the pipe element is designed such that all the surfaces, facing the horizontal base plane of the pipe element, of all the component overhangs provided on the pipe element, form with the horizontal base plane of the pipe element an angle which is greater than 35°.

Alternatively thereto, a surface of a component overhang facing a horizontal base plane of the pipe element, which forms with the horizontal base plane of the pipe element, an angle which is less than 35° can be supported by means of one supporting element or a plurality of supporting elements. By providing a supporting element, component geometries which otherwise cannot be readily printed can thus also be realized. It is understood that the pipe element, besides having component overhangs whose surfaces facing the horizontal base plane of the pipe element are supported by a supporting element, can also have component overhangs whose surfaces facing the horizontal base plane of the pipe element form with the horizontal base plane of the pipe element an angle which is greater than 35°, and thus can do without a supporting element.

The at least one supporting element which supports the surface of the component overhang facing the horizontal base plane of the pipe element, which surface forms with the horizontal base plane of the pipe element an angle which is less than 35°, extends preferably substantially perpendicularly to the horizontal base plane of the pipe element. As a result, an optimal supporting effect is achieved. At the same time, the supporting element is easily accessible.

Preferably, the supporting element is removable from the pipe element by a machining process after completion of the 3D printing process. For example, the supporting element can be placed and dimensioned such that it can be removed by milling or another suitable machining process when the 3D printing process is completed and a support of the surface of the component overhang facing the horizontal base plane of the pipe element is no longer required.

In a method for producing a pipe element which is suitable, in particular, for use in a fuel system of an aircraft, an inner pipe and an outer pipe sealingly surrounding the inner pipe and connected to the inner pipe are produced simultaneously by a 3D printing process. A pipe element constructed in one piece is thereby obtained.

Preferably, the pipe element is composed of metal and is produced by a 3D metal printing process.

In particular, the pipe element can be composed of titanium or a titanium alloy. Alternatively thereto, the pipe element can, however, also be made of other metallic materials, such as, e.g., aluminum or steel alloys.

Preferably, the pipe element is produced with such a geometry that a surface of a component overhang facing a horizontal base plane of the pipe element forms with the horizontal base plane of the pipe element an angle which is greater than 35°.

Alternatively or additionally thereto, by the 3D printing process there can be produced, simultaneously with the inner pipe and the outer pipe, at least one supporting element which supports a surface of a component overhang facing a horizontal base plane of the pipe element which forms with the horizontal base plane of the pipe element an angle which is less than 35°.

The at least one supporting element which supports the surface of the component overhang facing the horizontal base plane of the pipe element can extend substantially perpendicularly to the horizontal base plane of the pipe element.

Preferably, the at least one supporting element is removed from the pipe element by a machining process after completion of the 3D printing process. For example, the supporting element can be removed from the pipe element by milling or another suitable machining process.

Additionally or alternatively to the removal of the supporting element, after completion of the 3D printing process, a finishing of the pipe element by machining can be carried out, which may serve, for example, for fine machining of the final geometry of the pipe element or machining of surfaces of the pipe element.

A fuel system for installation in an aircraft comprises a pipe element described above.

### BRIEF DESCRIPTION OF THE DRAWINGS

A preferred embodiment of the invention will now be explained in more detail with the aid of the appended, schematic drawing, of which

FIG. 1 shows a three-dimensional representation of a pipe element suitable for use in a fuel system of an aircraft,

FIG. 2 shows a three-dimensional cutaway representation of the pipe element according to FIG. 1,

FIG. 3 shows a sectional view of the pipe element according to FIG. 1, and

FIGS. 4a and b show side views of two differently shaped pipe elements which illustrate the design of the pipe elements with and without supporting elements.

### DETAILED DESCRIPTION OF THE PREFERRED EMBODIMENTS

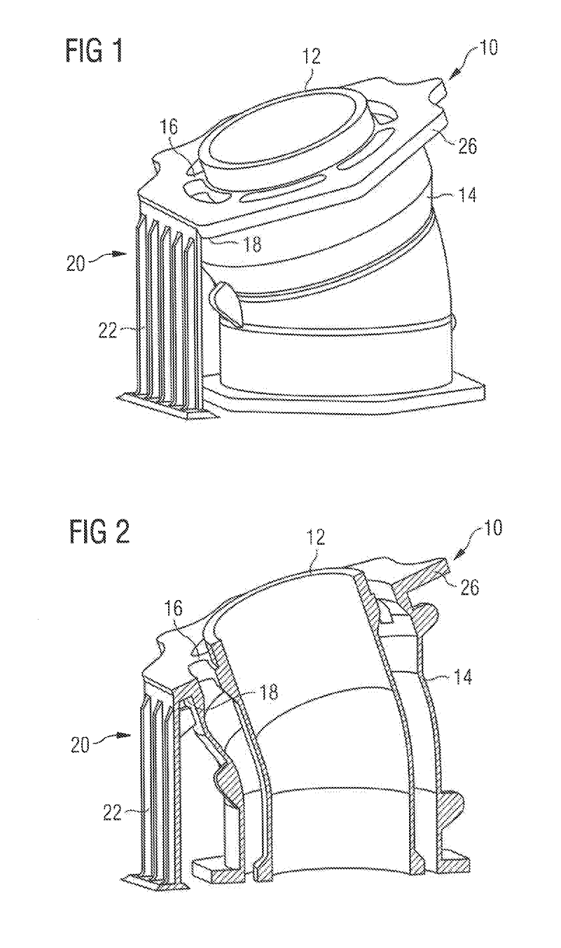

A pipe element 10 illustrated in FIGS. 1 to 3, which is provided for use in a fuel system of an aircraft, comprises an inner pipe 12. Furthermore, there is present an outer pipe 14 which sealingly surrounds the inner pipe 12 and is connected via webs 16 to the inner pipe 12. Such a design of the pipe element 10 ensures that, in the event of leakage, fuel escaping from the inner pipe 12 is caught in the outer pipe 14. The outer pipe 14 is connected to the aircraft surroundings via a suitable drainage system (not shown). In the event of leakage of the inner pipe 12, fuel caught in the outer pipe 14 can be safely discharged into the aircraft surroundings.

The pipe element 10 is constructed in one piece and produced by a 3D printing process. To produce the pipe element 10, a raw material powder layer is applied to a carrier and, depending on the desired geometry of the pipe element 10, subjected to laser radiation at selected locations. The laser is controlled by means of CAD data. The laser radiation penetrating the powder layer causes heating and consequently fusion or sintering of the raw material powder particles. Subsequently, successively further raw material powder layers are applied to the already-radiated layer on the carrier until the pipe element 10 has the desired shape and size.

In the preferred embodiment shown in the figures, the pipe element 10 is composed of metal, in particular titanium or a titanium alloy, and is produced by a 3D metal printing process. In the 3D metal printing process for producing the pipe element 10, therefore, metal powder particles, in particular titanium or titanium alloy powder particles, are processed as described above. Alternatively thereto, the pipe element may, however, also be made from other metallic materials, such as for example aluminum or steel alloys.

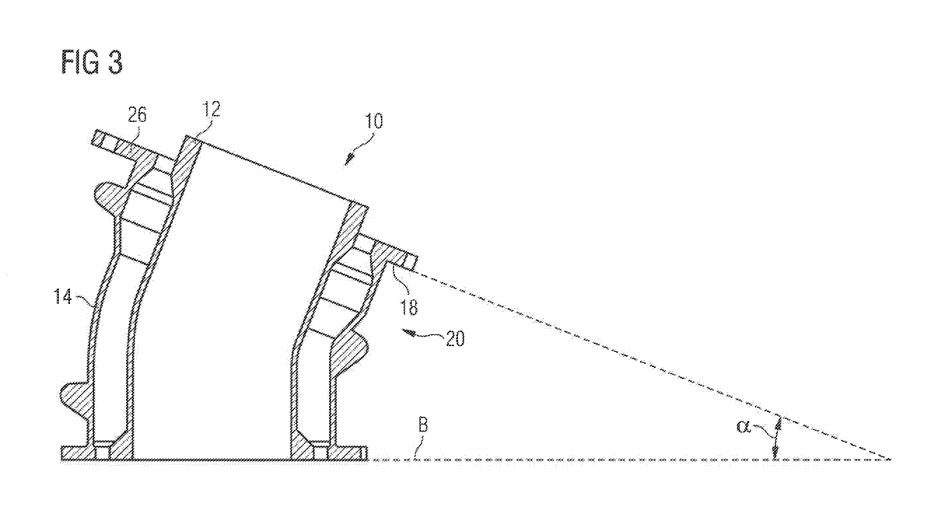

Basically, the aim is to design the geometry of the pipe element 10 such that, as far as possible, all the surfaces of a component overhang which face a horizontal base plane B of the pipe element 10 form with the horizontal base plane B of the pipe element 10 an angle which is greater than 35°. In the embodiment shown in the figures, however, a surface 18 of a component overhang 20, here the underside of a flange 26 provided on the pipe element 10, forms with the horizontal base plane B of the pipe element 10 an angle α which is less than 35°, see in particular FIG. 3.

In order to be able to produce the pipe element 10 with this geometry in a 3D printing process, there is provided at least one supporting element 22, illustrated in FIGS. 1 and 2, which is printed together with the inner pipe 12 and the outer pipe 14 and ensures during the layer-by-layer construction of the pipe element 10 that the component overhang 20 and the surface 18 of the component overhang 20 facing the horizontal base plane B of the pipe element are given the desired orientation and are maintained in this orientation. The supporting element 22 extends substantially perpendicularly to the base plane B of the pipe element 10.

After completion of the 3D printing process, the at least one supporting element 22 is removed from the pipe element 10 by a machining process. For example, the supporting element 22 can be removed from the pipe element 10 by milling in order to give the pipe element 10 the final shape illustrated in FIG. 3. Finally, a finishing of the pipe element 10 by machining is carried out, which may serve, for example, for fine machining of the final geometry of the pipe element 10 or machining of surfaces of the pipe element 10.

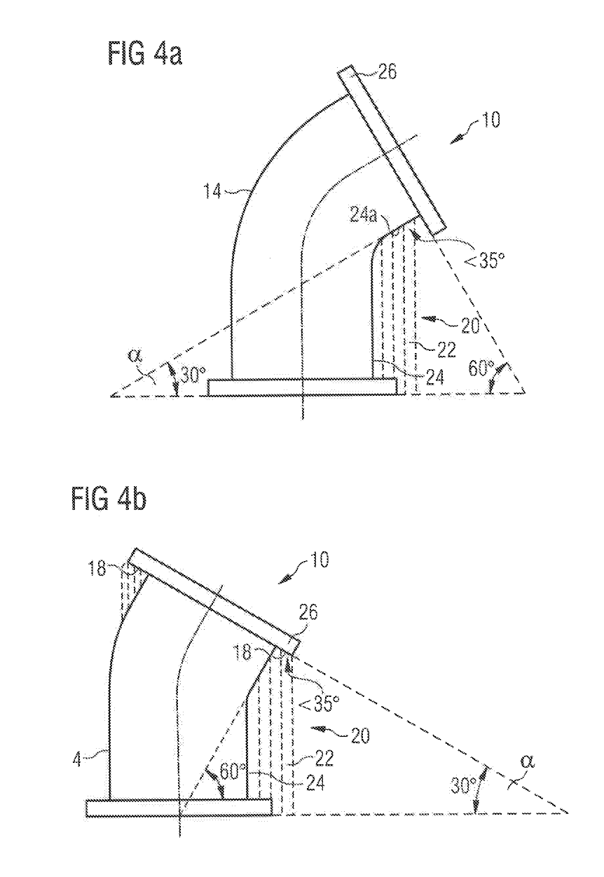

FIGS. 4a and b show different designs of the pipe element 10 which again illustrate the configuration of the pipe element 10 with and without supporting element(s) 22. In the pipe element 10 shown in FIG. 4a, the “critical” surface of the component overhang 20 facing the horizontal base plane B of the pipe element 10 is a section 24a of an outer surface 24 of the outer pipe 14 curved in the direction of the horizontal base plane B. This surface section 24a forms with the horizontal base plane B an angle α which is less than 35° and therefore must be supported by a suitable supporting element 22.

In the pipe element 10 shown in FIG. 4b, the outer pipe 14 of which is curved to a lesser degree, in contrast all the sections of the outer surface 24 form with the horizontal base plane B an angle α which is greater than 35°. Accordingly, these surfaces are produced without supporting elements in the course of a 3D printing process. In the pipe element 10 according to FIG. 4b, however, as in the arrangement according to FIG. 3, the surface 18, i.e., the underside of a flange 26 provided on the pipe element 10, forms the “critical” surface of the component overhang 20 facing the horizontal base plane B of the pipe element 10. This surface 18 forms with the horizontal base plane B an angle α of approx. 30°, i.e., an angle α which is less than 35° and therefore must be supported by means of suitable supporting elements 22 during the 3D printing process.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A pipe element suitable for use in a fuel system of an aircraft comprising:
an inner pipe and
an outer pipe sealingly surrounding the inner pipe and connected to the inner pipe,
wherein the pipe element is constructed in one piece and produced by a 3D printing process.

2. The pipe element according to claim 1, wherein the pipe element is composed of metal and is produced by a 3D metal printing process.

3. The pipe element according to claim 1, wherein the pipe element is composed of titanium or a titanium alloy, aluminum or a steel alloy.

4. The pipe element according to claim 1, wherein a surface of a component overhang facing a horizontal base plane of the pipe element forms with the horizontal base plane of the pipe element an angle which is greater than 35°.

5. The pipe element according to claim 1, wherein a surface of a component overhang facing a horizontal base plane of the pipe element, which forms with the horizontal base plane of the pipe element an angle which is less than 35°, is supported via at least one supporting element.

6. The pipe element according to claim 5, wherein the at least one supporting element extends substantially perpendicularly to the horizontal base plane of the pipe element.

7. The pipe element according to claim 5, wherein the supporting element is removable from the pipe element by a machining process after completion of the 3D printing process.

8. A method for producing a pipe element suitable for use in a fuel system of an aircraft, comprising the step of producing an inner pipe and an outer pipe sealingly surrounding the inner pipe and connected to the inner pipe simultaneously by a 3D printing process and thereby a pipe element constructed in one piece is obtained.

9. The method according to claim 8, wherein the pipe element is composed of metal and is produced by a 3D metal printing process.

10. The method according to claim 8, wherein the pipe element is composed of titanium or a titanium alloy, aluminum or a steel alloy.

11. The method according to claim 8, wherein the pipe element is produced with such a geometry that a surface of a component overhang facing a horizontal base plane of the pipe element forms with the horizontal base plane of the pipe element an angle which is greater than 35°.

12. The method according to claim 8, wherein by the 3D printing process there is produced simultaneously with the inner pipe and the outer pipe at least one supporting element which supports a surface of a component overhang facing a horizontal base plane of the pipe element, which overhang surface forms with the horizontal base plane of the pipe element an angle which is less than 35°.

13. The method according to claim 12, wherein the supporting element extends substantially perpendicularly to the horizontal base plane of the pipe element.

14. The method according to claim 12, wherein the at least one supporting element is removed from the pipe element by a machining process after completion of the 3D printing process.

15. A fuel system for installation in an aircraft comprising a pipe element according to claim 1.
